(19) United States
(12) Patent Application Publication
(10) Pub. No.: US 2016/0114707 A1
(43) Pub. Date: Apr. 28, 2016

(54) DEPLOYABLE ARMRESTS FOR A VEHICLE

(71) Applicants: Aidano Nascimento, Rochester, MI (US); David W. Whitehead, Rochester Hills, MI (US); Jeffrey T. Rodgers, Beverly Hills, MI (US)

(72) Inventors: Aidano Nascimento, Rochester, MI (US); David W. Whitehead, Rochester Hills, MI (US); Jeffrey T. Rodgers, Beverly Hills, MI (US)

(21) Appl. No.: 14/807,969

(22) Filed: Jul. 24, 2015

Related U.S. Application Data
(63) Continuation of application No. 13/895,187, filed on May 15, 2013.
(60) Provisional application No. 61/647,850, filed on May 16, 2012.

(51) Int. Cl. B60N 2/46; B62D 33/06

(52) U.S. Cl. CPC B60N 2/4606; B60N 2/466; B62D 33/06

(57) ABSTRACT

A deployable armrest system for a vehicle is provided. The system having: a pair of side walls configured to be located in a facing spaced relationship with respect to each other to define an operator area therebetween; and a pair of deployable armrests movably secured to the pair of side walls and configured for movement between a stowed position and a deployed position, wherein each of the pair of deployable armrests have a support member that can be flush with a surface of the pair of side walls when the pair of deployable armrests are in the stowed position and wherein the support member of each of the pair of deployable armrests extends outwardly from the surface of the pair of side walls when the pair of deployable armrests are in the deployed position.

### CROSS REFERENCE TO RELATED APPLICATIONS

This application is a continuation of U.S. patent application Ser. No. 13/895,187, filed May 15, 2013, which claims the benefit of U.S. Provisional Patent Application No. 61/647,850 filed May 16, 2012, the entire contents each of which are incorporated herein by reference thereto.

### BACKGROUND

Currently, most vehicles have an armrest located on the center console and/or attached to a door panel, the armrest allows the occupant to relax their arms while driving.

In recent years, automotive original equipment manufacturers (OEMs) have shown an interest in placing additional control interfaces (e.g., buttons etc.) in the armrest. However, the armrests are typically located away from the steering wheel of the vehicle and thus are inaccessible when an operator's arms are on the steering wheel.

Accordingly it is desirable to provide armrests that are configured for both operation of the additional control interfaces located therein as well as operation of the vehicle.

### SUMMARY OF THE INVENTION

In one embodiment, a deployable armrest system for a vehicle is provided. The system having: a pair of side walls configured to be located in a facing spaced relationship with respect to each other to define an operator area therebetween; and a pair of deployable armrests movably secured to the pair of side walls and configured for movement between a stowed position and a deployed position, wherein each of the pair of deployable armrests have a support member that can be flush with a surface of the pair of side walls when the pair of deployable armrests are in the stowed position and wherein the support member of each of the pair of deployable armrests extends outwardly from the surface of the pair of side walls when the pair of deployable armrests are in the deployed position.

In another embodiment a cockpit for a vehicle is provided, the cockpit having: a pair of side walls configured to be located in a facing spaced relationship with respect to each other to define an operator area therebetween; a steering mechanism located between distal ends of the pair of side walls, wherein the pair of side walls extend away from the steering mechanism; a pair of deployable armrests movably secured to the pair of side walls and configured for movement between a stowed position and a deployed position, wherein each of the pair of deployable armrests have a support member that is positioned to have a portion of an operator's arm located thereon when the operator is grasping the steering mechanism. In still another embodiment, the deployable armrests can be located in numerous other locations corresponding to other occupant (e.g., passenger) locations within the vehicle.

In yet another exemplary embodiment, a method of providing a deployable armrest system for a vehicle is provided, the method including the steps of: pivotally securing a pair of deployable armrests to a pair of side wall configured to be located in a facing spaced relationship with respect to each other to define an operator area therebetween, the pair of deployable armrests capable of movement between a stowed position and a deployed position, wherein each of the pair of deployable armrests have a support member that is flush with a surface of the pair of side walls when the pair of deployable armrests are in the stowed position and wherein the support member of each of the pair of deployable armrests extends outwardly from the surface of the pair of side walls when the pair of deployable armrests are in the deployed position.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIG. 1 illustrates a portion of a vehicle interior having a cockpit configured to surround an operator of the vehicle;

FIGS. 2-3 illustrate movement of a deployable armrest in the cockpit of FIG. 1; and

FIG. 4 illustrates a method and/or operation of a control system for operating the deployable armrests in accordance with one non-limiting exemplary embodiment of the present invention.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION

Referring now to the attached FIGS., a portion of a cockpit 10 of a vehicle is illustrated. Cockpit 10 has an instrument panel 12 and a steering wheel or other implement 14 of a steering system secured thereto. As illustrated, a pair of sidewall portions 16 extend from the instrument panel on either side of the steering wheel 14 in a rearward direction. As shown in the attached FIGS. and in one non-limiting exemplary embodiment, the side wall portions 16 extend from the instrument panel 12 starting at a location behind the steering wheel and extending rear ward therefrom. In addition, the side wall portions are positioned so that an operator's arms can be positioned on both of the deployable arm rests when they are gripping the steering wheel. The illustrated configuration provides a driver cockpit-like layout having an operator area 18 located between the sidewall portions 16 and steering wheel 14. Contrary to typical vehicle configurations the sidewall portions 16 are located in close proximity to the steering wheel such that a user's arms can be placed on a deployable armrest 20 when they are grasping the steering wheel 14. By allowing an operator to rest their arms on the deployable armrest 20 shoulder tension of the operator of the vehicle is illuminated especially when they are operating the vehicle for extended periods of time.

Although the armrests 20 are illustrated on a driver's side of the vehicle it is, of course, understood that the armrests 20 of exemplary embodiments of the present invention can be located anywhere within the vehicle for example on the passenger side of the vehicle as well as second or third rows of the vehicle.

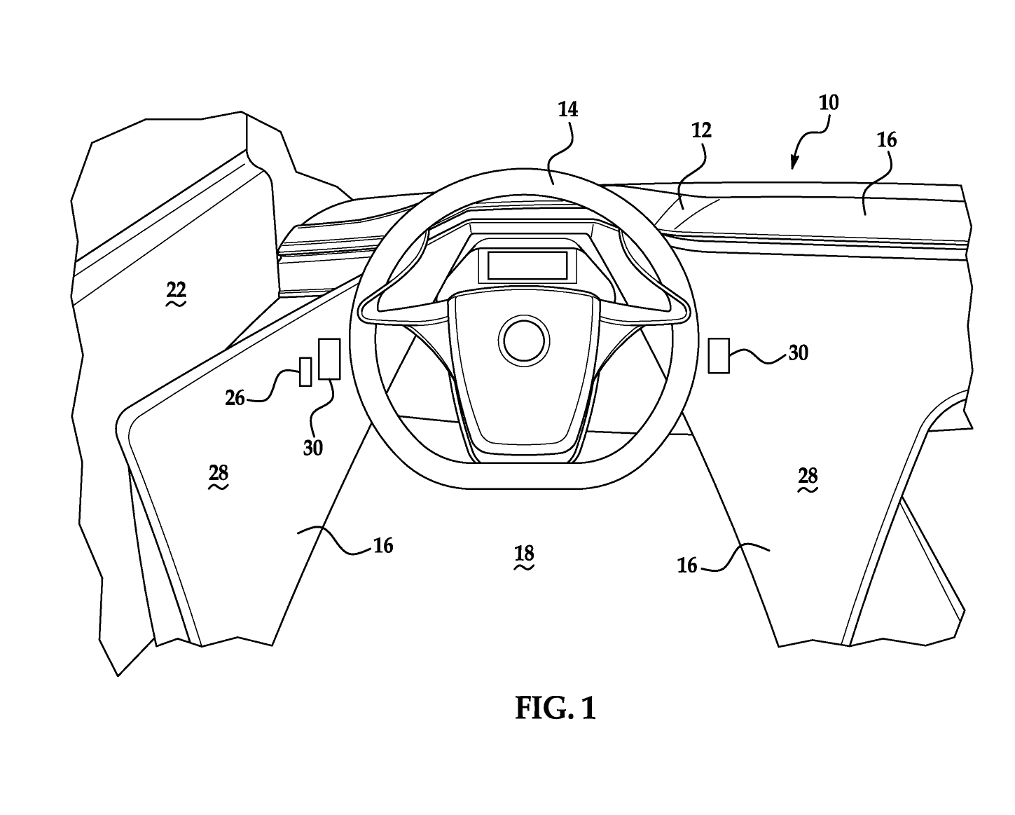

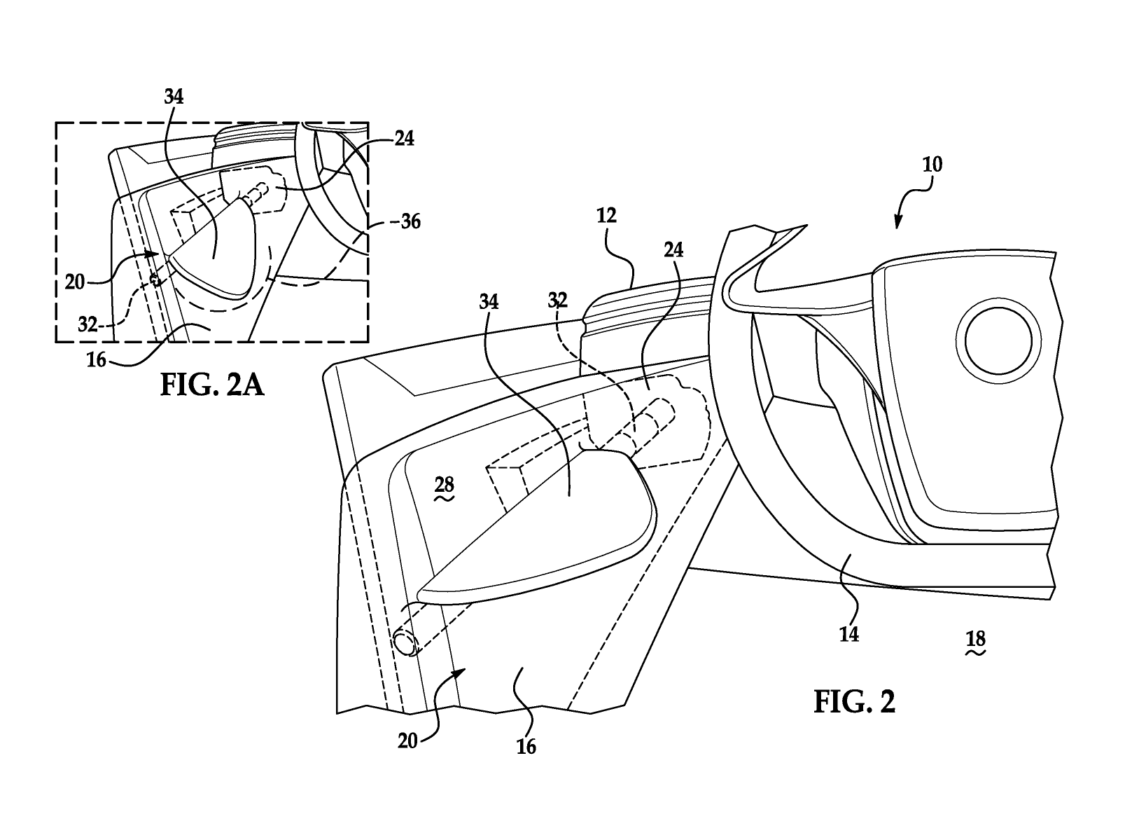

In accordance with one exemplary embodiment, each of the sidewall portions 16 are provided with a deployable armrest 20 that can be manipulated between a stowed position and a deployed position either manually or automatically or combination of the both. Accordingly, the deployable armrests can be moved into an optimal position (FIG. 2) during certain driving conditions, and moved into a stored position during other conditions (FIG. 1). This can be done in one non-limiting embodiment by using a controller so that action is automatic and intuitive. For example and in one non-limiting embodiment, the deployable arm rests are deployed during highway driving or when a predetermined speed or operating conditions has been established and detected for a predetermined time period or when a cruise control system has been operated, engaged or turned on. Similarly and when a predetermined speed has been detected and established for a predetermined time period or when a cruise control system has been disengaged or turned off, the deployable arm rests are stowed. The stowed configuration may also be consistent with city driving.

In one embodiment of the invention, one armrest 20 is located on the sidewall portion 16 that is an extension of the instrument panel 12, and another armrest 20 is located on the sidewall portion 16 that is secured to or integral with a door 22 (illustrated schematically) of the vehicle. The sidewall portion 16 that is secured to the door extends inwardly from an inboard side of the door or door module such that the sidewall portion 16 is located proximate to the steering wheel 14 as illustrated in the attached FIGS. Accordingly and as the door 22 opens and closes the side wall portion associated therewith moves with the door 22 so an individual may egress and ingress into the operator area 18.

In one embodiment, the armrests 20 are moved between the stowed position and the deployed position through use of an electric motor 24 coupled to the armrest 20 by a gear train. It is understood, that numerous equivalent devices may be employed to perform the required motions of the armrest 20. Electric motor 24 may be controlled by a controller having an activation button 26 located on a surface 28 of one of the side walls. Alternatively and in addition, the activation button 26 may be located on the steering wheel itself. Still further other vehicle systems may be controlled by buttons 30 located on surface 28 proximate to armrests 20 and/or the steering wheel itself.

In one embodiment, the armrests 20 are secured to rod members 32 rotatably secured to the sidewalls 16 and the rod members are coupled to the motor 24 via a gear train or any other equivalent means. Each armrest 20 will have a support member 34 that is received within a receiving area or cavity 36 of the sidewall 16 when the armrest is in the stowed position such that the support member 34 is flush with surface 28 defined by the sidewall 16. As the motor 24 or other equivalent device is operated the rod member 32 is rotated and the support member 34 moves into a non-flush position with respect to surface 28. Since armrests 20 are controlled by an electromechanical means numerous angular positions of the support member 34 with respect to surface 28 is possible. Thus, each individual operator may reconfigure the armrests as desired and accordingly, the support member 34 of the armrests 20 need not be in a flush position with respect to surface 28.

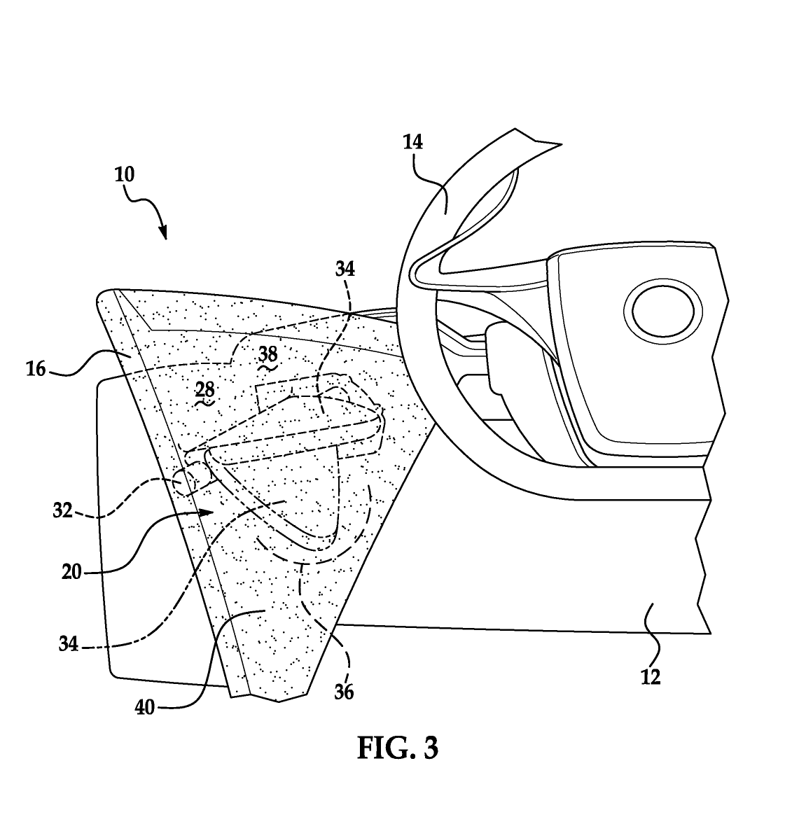

In one non-limiting alternative exemplary embodiment, surface 28 is defined by a material 38 (e.g., fabric, elastic fabric, elastic material or any other suitable material having elastic characteristics and/or resilient characteristics such that the material is capable of expanding and contracting or in other words, expanding from a first configuration upon deployment of the armrests and/or placement of the operator's arms thereon and returning to the first configuration upon stowing of the armrests and/or movement of the operator's arms therefrom) and the armrest 20 including support member 34 is covered by the fabric creating a stylized impact on the interior design and shape of the instrument panel since the material or fabric can expand and contract as the armrest 20 moves between the stowed position and the expanded position behind the material 38. For example and when the armrest is in the stowed position (FIG. 1), it is virtually invisible, giving the instrument panel an entirely different look as well as a more spacious interior compartment (FIG. 1). For example and as illustrated in at least FIG. 3, the side walls 16 will have a structural member 40 that is partially of totally covered by material 38. Accordingly and as the armrests move out of the receiving area 36 the material 38 will expand to allow for deployment of the armrests as well as placement of an operator's elbow, forearm etc. onto the support member 34 (e.g., the material 38 will stretch as an operator places their arms on the armrests). Once they remove their arms and also when the armrests are stowed the material 38 will contract due to its elastic or resilient characteristics and return to its non-expanded state corresponding to the stowed position and providing the appearance illustrated in at least FIG. 1. Alternatively, the armrest is a structural member that simply moves into an out of the receiving area or cavity 36 and there is no expandable elastic material 38 located over the armrest, other than perhaps an aesthetic covering located over support member 34.

Exemplary embodiments of the present invention provide armrests that support an operator's arms while driving while allowing them to be stowed when the vehicle operator won't want the armrests in the deployed position for other reasons. Accordingly, armrest 20 can be moved into an optimal position during certain driving conditions, and moved into a stored position during other conditions. This can be done mechanically or electromechanically by using a controller so that action is automatic and intuitive. Alternatively, the armrest 20 can be moved into the deployed position manually simply through the use of a mechanical actuator such as a catch or other equivalent member or alternatively through operation of a button that initiates deployment and stowing of the armrest via a mechanism initiated by operation of the button. Furthermore, the armrests 20 can be spring biased into the deployed position such that user manipulation of the catch or other equivalent member allows the armrest to be moved into the deployed position from the stowed position. Thereafter, the user simply depresses the armrests until the catch engages the same and retains it in the stowed position. Still further and as mentioned above, numerous positions of the armrests with respect to the sidewall are contemplated thus the stowed position may merely be a different angular position of the support surface with respect to surface 28 then the deployed position. In addition, the catch or other equivalent member may be configured to engage the armrest as it is moved from the deployed position to the stowed position thus, capturing it in numerous positions as it moves between the deployed position and the stowed position. Numerous other alternative embodiments for deploying and stowing the deployable armrests 20 are contemplated, non-limiting examples include voice activation, touchscreens, etc. In one non-limiting embodiment, one armrest 20 is located on an extension of the instrument panel, and another is located on the door panel.

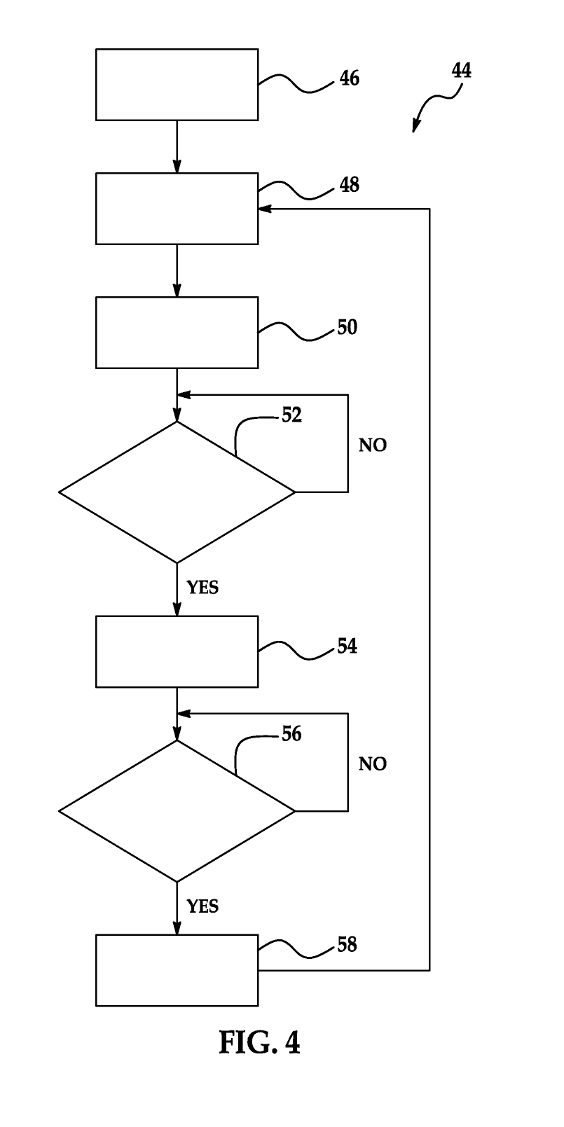

Referring now to FIG. 4, a flowchart or method 44 for operating the deployable armrests in accordance with one non-limiting exemplary embodiment of the present invention is illustrated. The flowchart or method 44 starts at box 46 and a first step, represented by box 48 determines whether the vehicle containing the deployable armrests 20 is operating or on. Then at the next step, represented by box 50 the system will determine whether the deployable armrests or operating system of the deployable armrests have been turned on. If so, the first decision node 52 will determine whether a predetermined deployment condition has been detected. This predetermined deployment condition can be anyone of the following non-limiting examples or combinations thereof: for example, a predetermined vehicle speed for a predetermined amount of time, activation of the vehicle's cruise control system. If the predetermined deployment condition is detected, then the system at box 54 will deploy the deployable armrests to the deployed position. Thereafter, the system will determine at decision node 56 whether a predetermined stowed condition is detected. This predetermined stowed condition can be anyone of the following non-limiting examples or combinations thereof; for example, a predetermined vehicle speed for a predetermined amount of time, deactivation of the vehicle's cruise control system, etc. If the predetermined stowed condition is detected, then the system at box 58 will stowed the deployable armrests to the stowed position. Thereafter, the system will return to box 48.

In an exemplary embodiment, the aforementioned flowchart or method 44 can be implemented by a microprocessor, microcontroller or other equivalent processing device operatively coupled to a plurality of sensors configured to detect the aforementioned conditions and capable of executing commands of computer readable data or program for executing a control algorithm that controls the operation of the deployable armrests. In order to perform the prescribed functions and desired processing, as well as the computations therefore (e.g., the execution of fourier analysis algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include input signal filtering to enable accurate sampling and conversion or acquisitions of such signals from communications interfaces. As described above, exemplary embodiments of the present invention can be implemented through computer-implemented processes and apparatuses for practicing those processes.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A deployable armrest system for a vehicle, comprising:
a pair of side walls configured to be located in a facing spaced relationship with respect to each other to define an operator area therebetween; and
a pair of deployable armrests movably secured to the pair of side walls and configured for movement between a stowed position and a deployed position, wherein each of the pair of deployable armrests have a support member that is flush with a surface of the pair of side walls when the pair of deployable armrests are in the stowed position and wherein the support member of each of the pair of deployable armrests extends outwardly from the surface of the pair of side walls when the pair of deployable armrests are in the deployed position, wherein each support member is received within a cavity located in each one of the pair of sidewalls when the pair of armrests are in the stowed position and wherein each one of the pair of armrests is located behind an elastic material that completely covers each support member and the cavity, wherein the elastic material expands from a first configuration when the pair of armrests are in the deployed position and contracts back to the first configuration when the pair of armrests are in the stowed position.

2. The deployable armrest system as in claim 1, wherein each of the pair of deployable armrests are secured to a member movably secured to one of the pair of side walls and wherein each one of the pair of deployable armrests are positioned such that when they are in the deployed position they are located to allow the vehicle operator's arms to be positioned thereon, while also grasping a steering wheel of the vehicle.

3. The deployable armrest system as in claim 2, wherein each member is rotated by a motor coupled thereto.

4. The deployable armrest system as in claim 3, wherein the motor is operated by a controller interface.

5. The deployable armrest system as in claim 1, wherein one of the sidewalls is secured to a vehicle door and the other one of the sidewalls extends from an instrument panel.

6. The deployable armrest system as in claim 1, wherein the armrests are moved between the stowed position and the deployed position by an electric motor.

7. The deployable armrest system as in claim 6, wherein the electric motor is coupled to the armrest by a gear train.

8. The deployable armrest system as in claim 7, wherein the electric motor is controlled by a controller having an activation button located on the surface of at least one of the pair of side walls.

9. The deployable armrest system as in claim 1, wherein the system further comprises actuation buttons located on the surface of at least one of the pair of side walls.

10. A cockpit for a vehicle, comprising:
a pair of side walls configured to be located in a facing spaced relationship with respect to each other to define an operator area therebetween;
a steering mechanism located between distal ends of the pair of side walls, wherein the pair of side walls extend away from the steering mechanism;
a pair of deployable armrests movably secured to the pair of side walls and configured for movement between a stowed position and a deployed position, wherein each one of the pair of deployable armrests have a support member that is positioned to have a portion of an operator's arm located thereon when the operator is grasping the steering mechanism, wherein each support member is received within a cavity located in each one of the pair of sidewalls when the pair of armrests are in the stowed position and wherein each one of the pair of armrests is located behind an elastic material that completely covers each support member and the cavity, wherein the elastic material expands from a first configuration when the pair of armrests are in the deployed position and contracts back to the first configuration when the pair of armrests are in the stowed position.

11. The cockpit as in claim 10, wherein the armrests are moved between the stowed position and the deployed position by an electric motor and wherein the electric motor is controlled by a controller having an activation button located on a surface of at least one of the pair of side walls.

12. A method of providing a deployable armrest system for a vehicle, comprising:
pivotally securing a pair of deployable armrests to a pair of side wall configured to be located in a facing spaced relationship with respect to each other to define an operator area therebetween, the pair of deployable armrests capable of movement between a stowed position and a deployed position, wherein each one of the pair of deployable armrests have a support member that is flush with a surface of the pair of side walls when the pair of deployable armrests are in the stowed position and wherein the support member of each one of the pair of deployable armrests extends outwardly from the surface of the pair of side walls when the pair of deployable armrests are in the deployed position, wherein each support member is received within a cavity located in each one of the pair of sidewalls when the pair of armrests are in the stowed position and wherein each one of the pair of armrests is located behind an elastic material that completely covers each support member and the cavity, wherein the elastic material expands from a first configuration when the pair of armrests are in the deployed position and contracts back to the first configuration when the pair of armrests are in the stowed position.

13. The method as in claim 12, wherein the pair of armrests are moved between the stowed position and the deployed position by an electric motor and wherein the electric motor is controlled by a controller having an activation button located on the surface of at least one of the pair of side walls.
